(19) United States
(12) Patent Application Publication
(10) Pub. No.: US 2008/0104288 A1
(43) Pub. Date: May 1, 2008

(54) ELECTRONIC DEVICE, COMPUTER SYSTEM COMPRISING THE SAME AND CONTROL METHOD THEREOF

(75) Inventor: Seung-joo LEE, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/766,480

(22) Filed: Jun. 21, 2007

(30) Foreign Application Priority Data
Oct. 31, 2006 (KR) 2006-106378

(51) Int. Cl. G06F 3/00

(52) U.S. Cl. 710/58

(57) ABSTRACT

A computer system includes a central processing unit (CPU) including at least one compensation port, a register setting part to set a control value corresponding to a predetermined specification of the compensation port, and a controlling part to save the set control value and to output a control signal corresponding to the control value.

### CROSS-REFERENCE TO RELATED APPLICATIONS

This application claims priority under U.S.C. §119(a) from Korean Patent Application No. 2006-0106378, filed on Oct. 31, 2006 in the Korean Intellectual Property Office, the disclosure of which is incorporated herein in its entirety by reference.

### BACKGROUND OF THE INVENTION

1. Field of the Invention

The present general inventive concept relates to an electronic device, a computer system comprising the same and a control method thereof, and more particularly to an electronic device comprising a central processing unit (CPU), a computer system comprising the same and a control method thereof.

2. Description of the Related Art

A conventional main board used in a computer system comprises a central processing unit (CPU), a memory, a plurality of circuit blocks such as an input/output interface, a chipset adjusting an overall system by hardware in controlling the CPU and the circuit block, and other types of computer hardware known in the art.

A typical chipset includes a north bridge which is positioned at a distance from a center part of the main board to be connected to a socket side of the CPU, for example, a memory control hub, and a south bridge which is positioned in a peripheral component interconnect (PCI) slot side to be connected to the north bridge. The north bridge and the south bridge are usually manufactured in the same manufacturing company. However, the CPU may be manufactured in a company different from a manufacturing company of the chipset. Generally, the CPU is connected to the chipset during a process of assembling the main board.

The manufacturing company of the CPU forms a predetermined compensation port to harmoniously adjust a communication between the CPU and the chipset, and provides the manufacturing company of the main board with a specification for designing the compensation port.

FIG. 1 is a control block diagram of a conventional computer system. As illustrated in FIG. 1, the CPU 10 comprises a plurality of compensation ports COMP0 through COMP8. Some compensation ports (e.g. compensation ports COMP2 and COMP8) are in a pull-up state where they are connected to a predetermined power source terminal Vcc, and some compensation ports (e.g. compensation ports COMP0 and COMP1) are in a pull-down state where they are connected to a ground terminal. The manufacturing company of the main board should design the main board according to pull-up or pull-down specifications of compensation ports which are provided by the manufacturing company of the CPU.

Therefore, the main board should be modified when the CPU is newly provided, and according to the kind of the CPU, and whenever a new CPU is to be manufactured.

### SUMMARY OF THE INVENTION

The present general inventive concept provides an electronic device which is capable of controlling a compensation port of a CPU without difficulty, a computer system comprising the same and a control method thereof.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept are achieved by providing a computer system comprising a central processing unit (CPU) comprising at least one compensation port, a register setting part to set a control value corresponding to a predetermined specification of the compensation port, and a controlling part to save the set control value and outputting a control signal corresponding to the control value.

The controlling part may comprise a register to save the control value, and at least one input/output terminal connected with the register to output the control signal.

The register setting part may comprise a basic input output system (BIOS).

The computer system may further comprise a switching part which is connected between the compensation port and the input/output terminal to connect the compensation port to either one of a first power source terminal inputting power of a first level and a second power source terminal which inputs the power of a second level according to the control signal.

The compensation port and the input/output terminal are plurally provided, and the switching part is plurally provided to connect either one of the compensation ports to either one of the input/output terminals.

One of the first power source terminal and the second power source terminal may be a ground terminal.

The computer system may further comprise a pull-down resistor connected to the ground terminal, and a pull-up resistor connected to the remaining power source terminal, wherein the switching part comprises a first switching device which is connected between the compensation port and the pull-up resistor, and a second switching device which is connected between the compensation port and the pull-down resistor and is turned off if the first switching device is turned on.

The first switching device and the second switching device may be junction transistors of which base terminals are connected to the input/output terminal.

The foregoing and/or other aspects and utilities of the present general inventive concept may also be achieved by providing a control method of a computer system comprising a central processing unit (CPU) having at least one compensation port, the control method comprising: setting a control value corresponding to a predetermined specification of the compensation port; and saving the set control value, and connecting the compensation port to either one of a first power source terminal having power corresponding to a first level and a second power source terminal having power corresponding to a second level.

The setting a control value may comprise inputting the control value to a predetermined register by using a BIOS.

One of the first power source terminal and the second power source terminal may be a ground terminal.

The foregoing and/or other aspects of the present general inventive concept may also be achieved by providing an electronic device capable of being connected to a central processing unit (CPU) having at least one compensation port, the electronic device comprising a register setting part to set a control value corresponding to a predetermined specification of the compensation port, a switching part connected to the compensation port to connect the compensation port to either one of a first power source terminal, which inputs power of a first level, or a second power source terminal, which inputs power of a second level, and a controlling part to save the set control value and to output a control signal corresponding to the control value to connect the compensation port to the first power source terminal or the second power source terminal.

The controlling part may comprise a register saving the control value, and at least one input/output terminal connected to the register to output the control signal.

The register setting part may comprise a BIOS.

One of the first power source terminal and the second power source terminal may be a ground terminal.

The electronic device may further comprise a pull-down resistor connected to the ground terminal, and a pull-up resistor connected to the remaining power source terminal, wherein the switching part comprises a first switching device which is connected between the compensation port and the pull-up resistor, and a second switching device which is connected between the compensation port and the pull-down resistor and is turned off if the first switching device is turned on.

The foregoing and/or other aspects and utilities of the present general inventive concept may also be achieved by providing a system including a computer and an electronic device, the system comprising a central processing unit (CPU) comprising at least one compensation port, and a switching part to selectively output a first level and a second level to the at least one compensation port.

The system may further comprise a register setting part to set a control value corresponding to a predetermined specification of the compensation port.

The system may further comprise a controlling part to save the set control value and to output a control signal corresponding to the control value to connect the compensation port to the first power source terminal or the second power source terminal.

The switching part may be connected to the at least one compensation port, and may comprise a first switching device to generate the first level, and a second switching device to generate the second level, and the first switching device and the second switching device exclusively operate to generate the corresponding one of the first level and the second level as a control signal to control the at least one compensation port.

The foregoing and/or other aspects and utilities of the present general inventive concept may also be achieved by providing a computer readable recording medium having embodied thereon a computer program to execute a method, wherein the method comprises setting a control value corresponding to a predetermined specification of the compensation port, and saving the set control value, and connecting the compensation port to either one of a first power source terminal having power corresponding to a first level and a second power source terminal having power corresponding to a second level.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a control block diagram of a conventional computer system.

FIG. 2A and FIG. 2B are control block diagrams of a computer system according to an exemplary embodiment of the present general inventive concept.

FIG. 3 is a flow chart illustrating a control method of the computer system according to an exemplary embodiment of the present general inventive concept.

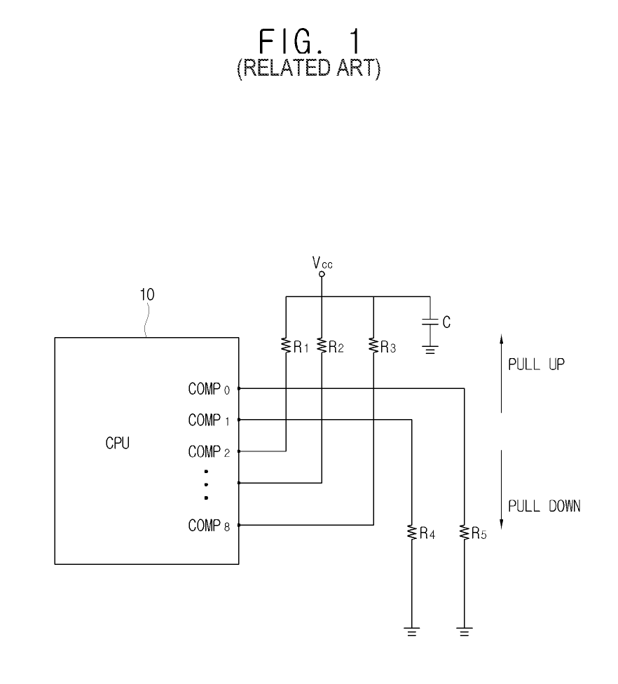

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

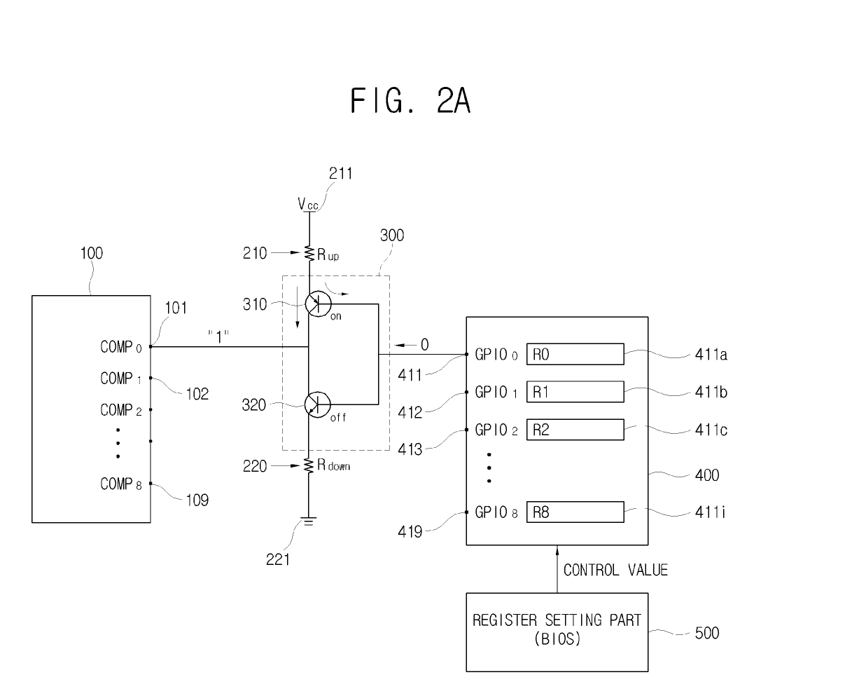

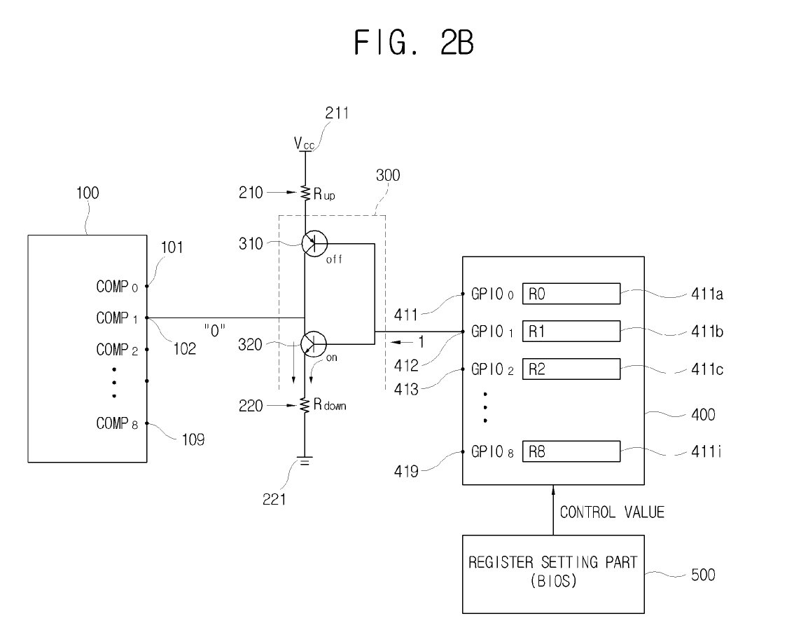

FIG. 2A and FIG. 2B are control block diagrams of a computer system according to an exemplary embodiment of the present general inventive concept, and more particularly, they represent a part of a main board comprising a CPU 100. In this specification of the present general inventive concept, the main board, which is capable of comprising the CPU 100, is defined as an electronic device. Generally, the electronic device comprises a memory, a plurality of circuit blocks such as an input/output interface, a north bridge and a south bridge which adjust an overall system by hardware in controlling the CPU and the circuit blocks, and computer hardware known in the art. The electronic device can be used in a computer, an electronic apparatus, etc., to control components and/or functions thereof.

FIG. 2A illustrates a first state of the computer system according to the exemplary embodiment of the present general inventive concept, and FIG. 2B illustrates a second state thereof.

As illustrated in FIG. 2A and FIG. 2B, the computer system comprises the CPU 100, a switching part 300 connected to the CPU 100, a controlling part 400 to control the switching part 300, and a register setting part 500 to set a control value. A pull-up resistor (Rup) 210 is connected between the switching part 300 and a first power source terminal (Vcc) 211 which inputs power corresponding to a first level. A pull-down resistor (Rdown) 220 is connected between the switching part 300 and a second power source terminal 221 which inputs power corresponding to a second level. The second power source terminal 221 according to the present embodiment is a ground terminal.

The CPU 100 comprises a plurality of compensation ports COMP0 through COMP8, and is connected to a chipset such as the north bridge and the south bridge to control the computer system. Since which characteristics of the CPU 100 the compensation ports 101 through 109 compensate specifically is subject to a trade secret of the manufacturing company thereof, its detail description is omitted in this specification.

The switching part 300 connects the compensation ports 101 through 109 with the pull-up resistor 210 or the pull-down resistor 220 according to a control signal output by the controlling part 400. However only a single switching part 300 is depicted in FIG. 2A corresponding to a clarified description, and the switching part 300 is actually connected to each of the compensation ports 101 through 109. Therefore, if the compensation ports 101 through 109 are provided plurally, the switching part 300 is also provided plurally.

The switching part 300 comprises a first switching device 310 which is connected between one of the compensation ports 101 through 109 and the pull-up resistor 210, and a second switching device 320 which is connected between one of the compensation ports 101 through 109 and the pull-down resistor 220, and has characteristics contrary to those of the first switching device 310. That is, the second switching device 320 is turned off if the first switching device 310 is turned on by a predetermined current, and the second switching device 320 is turned on if the first switching device 310 is turned off. Accordingly, the first switching device 310 and the second switching device 320 are provided with junction transistors having opposite current characteristics. As illustrated in FIG. 2A and FIG. 2B, the first switching device 310 is a PNP transistor which has an emitter terminal connected with the pull-up resistor 310, and a collector terminal connected with the compensation ports 101 through 109. The second switching device 320 is an NPN transistor which has an emitter terminal connected with the pull-down resistor 320, and a collector terminal connected with the compensation ports 101 through 109. Base terminals of both switching devices 310 and 320 are connected with the controlling part 400. Since only one of the switching devices 310 and 320 is turned on by the control signal output by the controlling part 400, the compensation ports 101 through 109 are in a state of either the pull-up state or the pull-down state.

The switching devices 310 and 320 are not limited to being junction transistors, and may be embodied by various circuit configurations, operators or other types of switching devices known in the art.

The controlling part 400 comprises a plurality of registers 411a through 411i and input/output terminals 411 through 419 respectively connected to the registers 411a through 411i. The controlling part 400 may be provided as a predetermined input/output chip having the input/output terminals 411 through 419.

Such an input/output chip may comprise a super I/O chip which is provided in the main board and has a general purpose input/output pin (GPIO) to output a predetermined control signal by a user's setting. The registers 411a through 411i save the control values, which correspond to the control signals to be output to the switching part 300, and output the control values to the input/output terminal 411 through 419.

The register setting part 500 sets the control value which corresponds to a predetermined specification of the compensation ports 101 through 109. In the present embodiment, the register setting part 500 is provided as a basic input output system (BIOS). A manufacturing company of the computer system may set or change a register value of a predetermined register by controlling the BIOS according to the specification of the compensation ports 101 through 109. In the present embodiment, the register value is the control value which corresponds to the specification of the compensation ports 101 through 109.

Conventionally, a circuit was designed on the main board by using hardware to connect the compensation port with the pull-up resistor or the pull-down resistor according to the specification of the compensation ports of the CPU. Accordingly, the main board must be modified through changing hardware or totally substituted to connect its resistors whenever the CPU is changed. However, according to the present general inventive concept, the switching device is provided to connect the compensation port to the pull-up resistor or the pull-down resistor, and the switching device may be controlled with software through the BIOS. That is, even if the CPU is substituted, the register value may be changed through the BIOS and thus the switching device may be freely controlled, so that the main board may not need to be modified through changing hardware as in the conventional main board.

As illustrated in FIG. 2A, if the control value saved in the first register 411a is a low signal “0,” the first switching device 310, which is a PNP transistor, is turned on by the control signal output from the input/output terminal 411, and the second switching device 320, which is an NPN transistor, is turned off. Therefore, the first compensation port 101 is connected to the pull-up resistor 210 through the first switching device 310. That is, the first compensation port 101 becomes “1” which represents the pull-up state.

In contrast, as illustrated in FIG. 2B, if the control value saved in the second register 411b is output as a high signal, that is “1,” the first switching device 310, which is the PNP transistor, is turned off, and the second switching device 320, which is the NPN transistor, is turned on. Therefore, the second compensation port 102 is connected to the pull-down resistor 220 through the second switching device 320. That is, the second compensation port 102 becomes “0” which represents the pull-down state.

Alternatively, it is possible that the first switching device 310 is connected to the pull-down resistor 220 while the second switching device 320 is connected to the pull-up resistor 210. Accordingly, in contrast to the above description, the compensation ports 101 through 109 become the pull-up state if the control value is “1”, and the compensation ports 101 through 109 become the pull-down state if the control value is “0”. That is, the user may freely change the switching devices 310 and 320 and the control value.

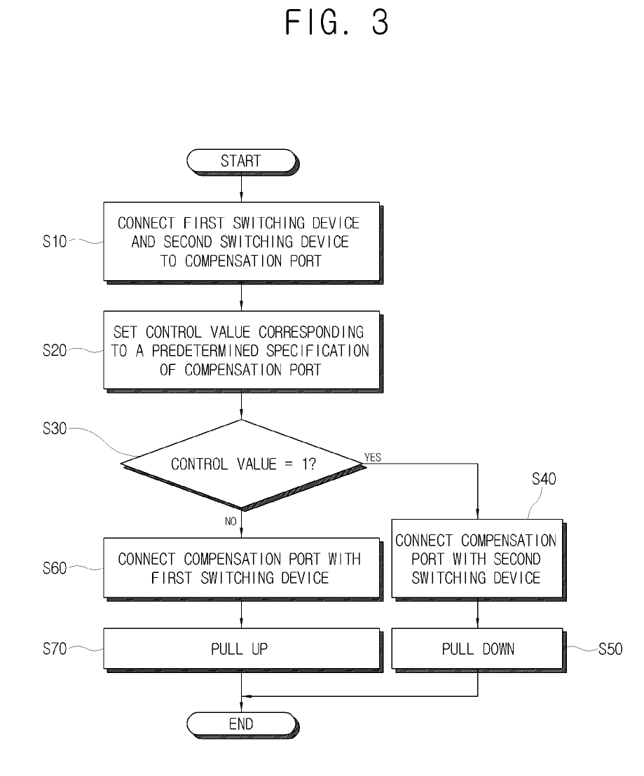

FIG. 3 is a flow diagram illustrating a control method of the computer system according to an exemplary embodiment of the present general inventive concept. Referring to FIG. 3, the control method of the computer system according to the present embodiment is described as follows.

Firstly, the switching part 300, which comprises the first switching device 310 and the second switching device 320, is connected to each of the compensation ports 101 through 109 of the CPU 100 in operation S10. The first switching device 310, which is the PNP transistor, is connected to the pull-up resistor 210. The second switching device 320, which is the NPN transistor, is connected to the pull-down resistor 220.

Then, the control value which corresponds to the predetermined specification of the compensation ports 101 through 109 is set through the register setting part 500 in operation S20. The control value is the register value which decides between a pull-up or pull-down state of the compensation ports 101 through 109.

If the control value is “1,” the compensation ports 101 through 109 are connected with the second switching device 320 in operation S30 and operation S40. That is, the compensation ports 101 through 109 become the pull-down state during operation S50.

In contrast, if the control value is “0,” the compensation ports 101 through 109 are connected with the first switching device 310 in operation S30 and operation S60, and the compensation ports 101 through 109 become the pull-up state during operation S70.

According to the present general inventive concept, the compensation ports 101 through 109 of the CPU 100 may be easily changed to be the pull-up state or the pull-down state by controlling the BIOS without modifying hardware of the main board.

As described above, according to the present general inventive concept, an electronic device capable of easily controlling the compensation port of the CPU, a computer system comprising the electronic device, and a control method of the computer system may be provided.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A computer system, comprising:
a central processing unit (CPU) comprising at least one compensation port;
a register setting part to set a control value corresponding to a predetermined specification of the compensation port; and
a controlling part to save the set control value and to output a control signal corresponding to the control value to the corresponding compensation port.

2. The computer system according to claim 1, wherein the controlling part comprises:
a register to save the control value; and
at least one input/output terminal connected to the register to output the control signal.

3. The computer system according to claim 1, wherein the register setting part comprises a basic input output system (BIOS).

4. The computer system according to claim 2, further comprising a switching part connected between the compensation port and the input/output terminal to connect the compensation port to either one of a first power source terminal inputting power of a first level and a second power source terminal which inputs power of a second level according to the control signal.

5. The computer system according to claim 4, wherein the compensation port and the input/output terminal are plurally provided, and the switching part is plurally provided to connect either one of the compensation ports to either one of the input/output terminals.

6. The computer system according to claim 4, wherein one of the first power source terminal and the second power source terminal is a ground terminal.

7. The computer system according to claim 6, further comprising:
a pull-down resistor connected to the ground terminal; and
a pull-up resistor connected to the remaining power source terminal,
wherein the switching part comprises a first switching device which is connected between the compensation port and the pull-up resistor, and a second switching device which is connected between the compensation port and the pull-down resistor and is turned off if the first switching device is turned on.

8. The computer system according to claim 7, wherein the first switching device and the second switching device are junction transistors of which base terminals are connected to the input/output terminal.

9. A control method of a computer system comprising a central processing unit (CPU) having at least one compensation port, the control method comprising:
setting a control value corresponding to a predetermined specification of the compensation port; and
saving the set control value, and connecting the compensation port to either one of a first power source terminal having power corresponding to a first level and a second power source terminal having power corresponding to a second level.

10. The control method of the computer system according to claim 9, wherein the setting a control value comprises inputting the control value to a predetermined register by using a BIOS.

11. The control method of the computer system according to claim 9, wherein one of the first power source terminal and the second power source terminal is a ground terminal.

12. An electronic device capable of being connected to a central processing unit (CPU) having at least one compensation port, the electronic device comprising:
a register setting part to set a control value corresponding to a predetermined specification of the compensation port;
a switching part connected to the compensation port to connect the compensation port to either one of a first power source terminal, which inputs power of a first level, or a second power source terminal, which inputs power of a second level; and
a controlling part to save the set control value and to output a control signal corresponding to the control value to connect the compensation port to the first power source terminal or the second power source terminal.

13. The electronic device according to claim 12, wherein the controlling part comprises:
a register to save the control value; and
at least one input/output terminal connected to the register to output the control signal.

14. The electronic device according to claim 12, wherein the register setting part comprises a BIOS.

15. The electronic device according to claim 12, wherein one of the first power source terminal and the second power source terminal is a ground terminal.

16. The electronic device according to claim 15, further comprising:
a pull-down resistor connected to the ground terminal; and
a pull-up resistor connected to the remaining power source terminal,
wherein the switching part comprises a first switching device which is connected between the compensation port and the pull-up resistor, and a second switching device which is connected between the compensation port and the pull-down resistor and is turned off if the first switching device is turned on.

17. A system including a computer and an electronic device, the system comprising:
a central processing unit (CPU) comprising at least one compensation port; and
a switching part to selectively output a first level and a second level to the at least one compensation port.

18. The system of claim 17, further comprising:
a register setting part to set a control value corresponding to a predetermined specification of the compensation port.

19. The system of claim 18, further comprising:
a controlling part to save the set control value and to output a control signal corresponding to the control value to connect the compensation port to the first power source terminal or the second power source terminal.

20. The system of claim 17, wherein the switching part is connected to the at least one compensation port, and comprises:
a first switching device to generate the first level; and
a second switching device to generate the second level, and the first switching device and the second switching device exclusively operate to generate the corresponding one of the first level and the second level as a control signal to control the at least one compensation port.

21. A computer readable recording medium having embodied thereon a computer program to execute a method, wherein the method comprises:
setting a control value corresponding to a predetermined specification of the compensation port; and
saving the set control value, and connecting the compensation port to either one of a first power source terminal having power corresponding to a first level and a second power source terminal having power corresponding to a second level.
